(19) United States
(12) Patent Application Publication
(10) Pub. No.: US 2011/0227705 A1
(43) Pub. Date: Sep. 22, 2011

(54) SYSTEM FOR CHECKING THE LOCATION OF EQUIPMRNT

(75) Inventor: Boris Alekseevich Khozyainov, Korolev (RU)

(73) Assignee: Boris Alekseevich Khozyainov, Korolev (RU)

(21) Appl. No.: 13/129,121

(22) PCT Filed: Nov. 11, 2009
(86) PCT No.: PCT/RU2009/000610

§ 371 Date: May 13, 2011

(30) Foreign Application Priority Data
Nov. 14, 2008 (RU) 2008144827

(51) Int. Cl. H04Q 5/22

(52) U.S. Cl. 340/10.1

(57) ABSTRACT

The invention relates to communication technology. Use of the invention allows to check the location of equipment in telecommunication racks. This technical result is achieved by steps of: providing the rail of rack with lengthy antenna connected to an RFID interrogator; installing on the rail sensors of location that change their state when equipment is mounted in the rack; providing said equipment with RFID tags. When equipment is set into the rack the equipment and its location is identified correlating changing of the RFID tags replay signal and changing of location sensors state.

### FIELD OF THE INVENTION

The present invention relates to the communication technology and can be used for checking the location of network and telecommunication equipment.

### BACKGROUND OF THE INVENTION

The most closest analog is described in the patent application US 2007/0095907 (May 3, 2007) including the system based on RFID technology. FIG. 2A of the application presents a 19 inches telecommunication rack where network devices containing RFID tags (204) are installed. An RFID reader (interrogator) is placed on the door of the rack. The RFID reader moves automatically up and down along the devices and read the RFID tags. Having information about the RFID reader position and ID of the devices the system determines location of the network devices within the rack. A disadvantage of the system is the movable RFID reader that reduces reliability.

In addition there is the system described in the Russian patent 74482 (Jun. 27, 2008). Port of a patch panel are provided with the sensor of presence of plug in the port. Near-filed RFID tags are installed on patch cord plugs. The RFID tags change their reply signal using a switch in the antenna circuit when a plug is connected to a patch panel port. The connection is identified correlating the actuation of the sensor of presence of plug and changing of reply signal of the RFID tag that take place at the closest time.

### SUMMARY OF THE INVENTION

Thus, the object of the present invention consists in developing such means for checking the location of equipment within a telecommunication rack which allows to determine position of a network devices in the rack using RFID tags and a fixed (motionless) RFID reader.

In order for achieving the technical result, it is proposed a system for checking the location of equipment, comprising a rack with a rail for securing in place equipment; at least one computer system; at least one RFID interrogator connected to said computer system; at least one unit of equipment is intended to install into said rack and provided with an RFID tag which tag contains the identifier of said unit of equipment; characterized in that the system comprises a lengthy near-field antenna connected to said RFID interrogator and located at least partially along said rail; comprises at least one sensor of equipment location which sensor correlates with a part of said rail and changes its state when said unit of equipment is located at said part of rail; and said RFID tag changes its reply signal perceived by said RFID interrogator when said unit of equipment is placed in said rack; said computer system determines the part of said rail where said unit of equipment is located and identifies said unit of equipment correlating the change of said sensor/sensors signal/signals and the change of replay signal of said RFID tag perceived by said RFID interrogator which changes are nearest by time.

It is possible the embodiment where said sensor of equipment location comprises an RFID tag. The tag can contain a switch which switch changes electrical parameters of the antenna of said RFID tag and the switch is controlled by magnetic field.

The RFID interrogator antenna can be a radiating coaxial cable or a loop antenna where one long side of said loop is located along said rail.

To reduce the system cost RFID interrogator can have several antennas connected to the RFID interrogator through an internal or/and external multiplexer.

In some cases the RFID interrogator feeds signal to its antenna when the door of rack is open or a human is near the rack.

Finally the antenna can be located along more than one rail.

### BRIEF DESCRIPTION OF THE DRAWINGS

FIG. 1 depicts the general block diagram of the system for checking the location of equipment of the present invention.

### DETAILED DESCRIPTION OF THE INVENTION

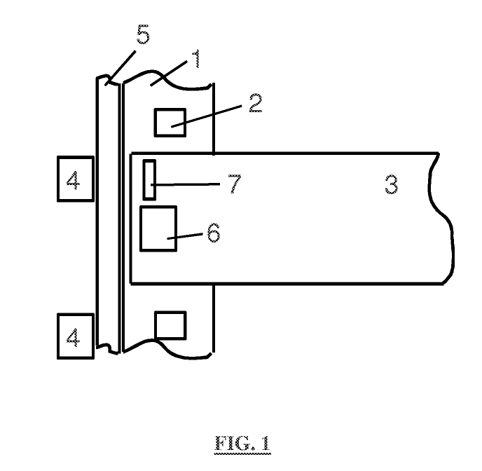

The system of the present invention can be implemented in several similar embodiments that are, nevertheless, implemented in the same system as presented at FIG. 1. Every telecommunication rack (here and further a rack means any system for placement network equipment vertically including an enclosure) has rails 1 with holes 2 for equipment installing. FIG. 1 presents a part of the rail 1 and a unit of equipment 3 which can be a router, a switch, a UPS or a server etc. Sensors of equipment location 4 are mounted along the rail 1. They are correlated with specific height of the rail 1 in the rack and change their state when a unit of equipment is placed in the rack or frame. Because height of equipment is usually multiple of 1 U (about 4.5 centimeters) it is enough to install the sensors along rail 1 in 1 U (but it is possible more frequently or more sparse according to a user wish). If the sensors are located more frequently than several sensors change their state at the same time.

Embodiment of the sensors can be different. For example it can be mechanical switch with a long actuator. The actuator is pressed by the box of equipment when the equipment are located in the rack. Otherwise the sensor can be an RFID tag. The tag changes its replay signal perceiving by an RFID interrogator because of proximity the RFID tag to metal of the equipment box.

FIG. 1 presents the sensor based on a near-filed RFID tag (as described in the patent RU74482). The sensor comprises hermetically sealed dry reed switch controlled by magnetic field. The switch is a part of the RFID tag antenna. If magnetic field appears near the sensor then the antenna circuit closes or opens (depends on the reed type). The RFID tag becomes readable or unreadable for interrogation because the resonant frequency of the antenna changes also. Let the reed switch is normal open.

The near-field antenna 5 or part of the RFID interrogator antenna located along the rail 1 also. The antenna 5 can be radiating coaxial cable (special or ordinary which can radiate because of in-phase antenna current) or long rectangular wire loop with impedance matching elements. In the last case position 5 of FIG. 1 is one of long side of the loop. The RFID interrogator is connected to the computer system (for example PC) over Ethernet. The RFID interrogator and the computer system are functional (not physical) devices. For example many RFID interrogator has a power processor and tasks of the computer system can be performed using resources of the RFID interrogator.

The near-field RFID tag 6 (for example Impinj PaperClip of EPC Gen2 standard) and the permanent magnet 7 are mounted on the surface of the equipment unit 3. The RFID interrogator using near-field antenna 5 poles available RFID tags. Near (magnetic) field has a small operation area. Moreover the area can be changed if different power is fed to the RFID interrogator antenna. Thus RFID tags can be read at very proximity to the antenna 5. When the equipment 3 is not installed in the rack the sensors 4 is unavailable because its antennas are open and RFID tags 6 is unavailable because of distance to the antenna 5. When the equipment 3 is mounted on the rail 1 the magnet 7 close the reed switch of the sensor 4 (the top sensor at FIG. 1). The identifier of the sensor becomes available to the RFID interrogator. Thus the height of the equipment installation is determined. Correlating time of the sensor 4 actuation and the time of availability of the tag 6 to the RFID interrogator it is possible to determine what specific equipment has been just mounted in the rack. The computer system of this invitation keeps correlations between the tag 6 identifier and attributes of the equipment, for example, the equipment serial number, the height measured in rack units, electrical power etc. After equipment installation occupancy, power consumption and other characteristics of the rack can be calculated.

Apparently an RFID with a reed switch (as the RFID tag 4) can be mounted on the equipment unit instead of the ordinary tag 6.

More than one RFID antennas 5 can be connected to the RFID interrogator using an internal or external antenna multiplexer. Moreover an external multiplexer can be connected to an antenna output of the internal multiplexer of RFID interrogator. Then the external multiplexer can be controlled using GPIO pins that have many modern RFID interrogators have.

In order to reduce emission of radio energy the RFID signal to the antenna can be fed when an administrator (human) is in front of the rack. Because only administrator can change the location of equipment. A sensor of movement connected to RFID interrogator GPIO can detect presence of administrator. A video camcorder can achieve the same result. Apparently if the rack has a door and the door is closed than there is no sense to check the location of the equipment.

In order to reduce cost of the system one radiating coaxial antenna can serve two or three racks. The antenna can be one piece of cable or pieces of cable connected using T-splitter.

1. A system for checking the location of equipment, comprising:
a rack with a rail for securing in place equipment;
at least one computer system;
at least one RFID interrogator connected to said computer system;
at least one unit of equipment is intended to install into said rack and provided with an RFID tag which tag contains the identifier of said unit of equipment;
characterized in that the system
comprises a lengthy near-field antenna connected to said RFID interrogator and located at least partially along said rail;
comprises at least one sensor of equipment location which sensor correlates with a part of said rail and changes its state when said unit of equipment is located at said part of rail; and
said RFID tag changes its reply signal perceived by said RFID interrogator when said unit of equipment is placed in said rack;
said computer system determines the part of said rail where said unit of equipment is located and identifies said unit of equipment correlating the change of said sensor/sensors signal/signals and the change of replay signal of said RFID tag perceived by said RFID interrogator which changes are nearest by time.

2. The system of claim 1, wherein said sensor of equipment location comprises an RFID tag.

3. The system of claim 2, wherein said sensor of equipment location comprises a switch which switch changes electrical parameters of the antenna of said RFID tag.

4. The system of claim 3, wherein said switch is a magnetic controlled switch.

5. The system of claim 1, wherein said antenna is a radiating coaxial cable.

6. The system of claim 1, wherein said antenna is a loop antenna where one long side of said loop is located along said rail.

7. The system of claim 1, wherein said RFID interrogator has several antennas connected to said RFID interrogator through an internal or/and external multiplexer.

8. The system of claim 1, wherein said RFID interrogator feeds signal to said antenna when the door of said rack is open.

9. The system of claim 1, wherein said RFID interrogator feeds signal to said antenna when a human is near said rack.

10. The system of claim 1, wherein said antenna is located along more than one rail.
